(19) United States
(12) Patent Application Publication
(10) Pub. No.: US 2008/0208599 A1
(43) Pub. Date: Aug. 28, 2008

(54) Modifying a speech signal

(75) Inventors: Olivier Rosec, Lannion (FR); Damien Vincent, Milpitas, CA (US)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/007,798

(22) Filed: Jan. 15, 2008

(30) Foreign Application Priority Data
Jan. 15, 2007 (FR) 07 00257

(51) Int. Cl. G10L 21/00

(52) U.S. Cl. 704/278; 704/E21.001

(57) ABSTRACT

Disclosed is a device and method for modifying acoustic characteristics of a speech signal. The method comprises decomposing the signal into a parametric portion and a non-parametric residue; estimating the temporal envelope of the residue; modifying acoustic characteristics of the parametric portion and of the residue in compliance with modification instructions; determining a new temporal envelope for the modified residue using said modification instructions; and synthesizing a modified speech signal from the modified parametric portion and from the residue as modified and with the new temporal envelope.

This application claims the benefit of French Patent Application No. 07 00257, filed on Jan. 15, 2007, which is incorporated by reference for all purposes as if fully set forth herein.

### FIELD OF THE DISCLOSURE

The present invention relates to modifying speech, and more particularly to modifying the acoustic parameters of speech signals decomposed into a parametric portion and a non-parametric portion.

### BACKGROUND OF THE DISCLOSURE

It is known to decompose speech signals using so-called filter-excitation models. In such models, speech is considered as being a glottal excitation that is transformed by a filter representing the vocal tract.

The excitation is obtained by applying inverse filtering to the speech signal. It sometimes comprises a portion that is likewise parametric together with a residue. The residue corresponds to the difference between the excitation and the corresponding parametric model.

When modifying speech signals, information concerning frequency, rhythm, or timbre, are modified using the parameters of the model.

Nevertheless, such modifications give rise to audible distortion, in particular because of a lack of control over temporal coherence, in particular during modifications to the fundamental frequency or timbre.

For example, the document “Applying the harmonic plus noise model in concatenative speech synthesis”, IEEE Transactions on Speech and Audio Processing, Vol. 9(1), pp. 21-29, January 2001, by Y. Stylianou, proposals are made to use a harmonic plus noise model (HNM), with temporal modulation of the noisy portion so that it becomes naturally integrated in the deterministic portion. However, that method does not preserve the temporal coherence of the deterministic portion.

Another approach consists in having a model of the glottal source that is sufficiently compact for the appearance of the glottal signal to be capable of being kept under control while modifying the signal. Such an approach is described for example in the document “Toward a high-quality singing synthesizer with vocal texture control”, Stanford University, 2002 by H. L. Lu. Nevertheless, such a model does not capture all of the information from the glottal signal. Residual information needs to be conserved, and modification thereof raises the above-mentioned problem of lack of temporal coherence.

In the document “Time-scale modification of complex acoustic signals”, ICASSP1993, Vol. 1, pp. 213-216, 1993 by T. F. Quatieri, R. B. Dunn, and T. E. Hanna, proposals are made for a method of modifying speech signals that seeks to preserve both the spectral envelope and the temporal envelope. That method is applied solely to modifying the duration of acoustic signals, and it is not practical insofar as it is theoretically not possible to guarantee that satisfactory solutions exist simultaneously for both of those properties. Furthermore, no convergent result exists for the proposed algorithm, and consequently that method does not make it possible to achieve sufficient control over the characteristics of the resulting signal.

Thus, there is no technique in existence that makes it possible to modify speech signals while ensuring good coherence at temporal level.

### SUMMARY

One of the objects of the present invention is to enable such a modification to be performed.

To this end, the present invention provides a method of modifying the acoustic characteristics of a speech signal, the method comprising:
decomposing the signal into a parametric portion and a non-parametric residue;
estimating the temporal envelope of the residue;
modifying acoustic characteristics of the parametric portion and of the residue in compliance with modification instructions;
determining a new temporal envelope for the modified residue using said modification instructions; and
synthesizing a modified speech signal from the modified parametric portion and from the residue as modified and with the new temporal envelope.

Because of the specific processing performed on the temporal characteristics of the residue, the temporal coherence of the modified signal is improved.

In an implementation of the invention, said decomposition of the signal is decomposition in application of an excitation-filter type model. Such a decomposition makes it possible to obtain a residue that corresponds to glottal excitation.

Advantageously, estimating the temporal envelope of the residue comprises estimating a first envelope and then performing temporal smoothing on said first envelope. This implementation makes it possible to obtain a better estimate of the temporal envelope.

In a particular implementation, the method further comprises temporal normalization of the residue as a function of the estimated temporal envelope. This makes it possible to obtain an expression for the residue that is substantially independent of its temporal characteristics.

In a particular implementation, the temporal normalization of the residue comprises dividing the residue by the estimated temporal envelope.

In another implementation, the determination of a new temporal envelope for the residue comprises modifying parameters of the temporal envelope of the residue in compliance with said modification instructions and applying the modified temporal envelope to the normalized residue.

In an implementation, estimating the temporal envelope and determining a new temporal envelope are the same operation.

Advantageously, modifying the acoustic characteristics comprises modifying fundamental frequency and duration information concerning both the parametric portion and the residue.

Furthermore, the invention also provides a program for implementing the method described above, and a corresponding device.

### BRIEF DESCRIPTION OF THE DRAWINGS

The invention can be better understood in the light of the description made by way of example and with reference to the figures, in which:

FIG. 1 is a general flow chart of the method of the invention; and

FIGS. 2A to 2D show different stages in the processing of a speech signal.

### DETAILED DESCRIPTION OF THE ILLUSTRATED EMBODIMENTS

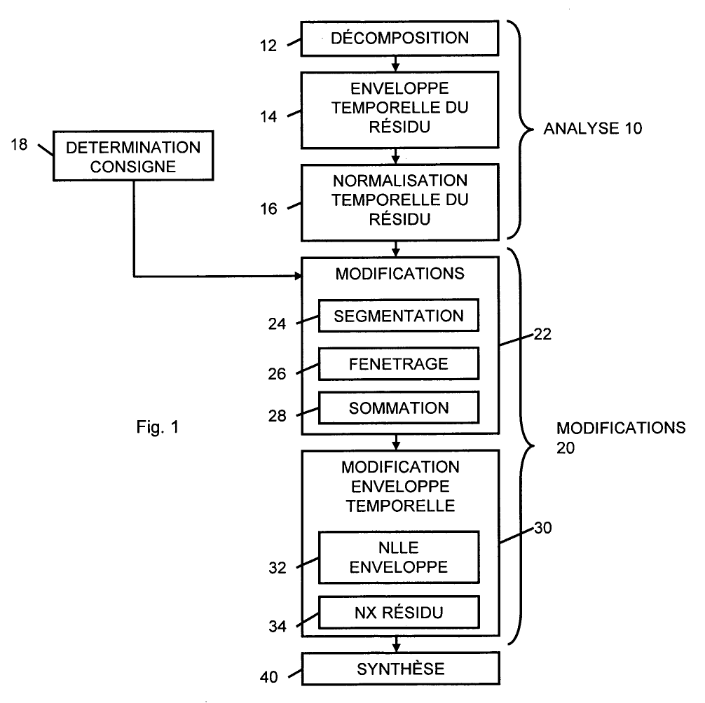

The method shown with reference to FIG. 1 begins with a step 10 of analyzing the speech signal, which step includes decomposition 12 in accordance with an excitation-filter model, i.e. decomposing the speech signal into a parametric portion and into a non-parametric portion referred to as the “residue” and corresponding to a portion of the glottal excitation.

A common practice for implementing step 12 is to use linear prediction techniques such as those described in the document by J. Makhoul in “Linear prediction: a tutorial review”, Proceedings of the IEEE, Vol. 63(4), pp. 561-580, April 1975.

In the embodiment described by way of example, the speech signal s(n) is decomposed in step 12 with the help of autoregression, known as the “AR” model, having the following form:

$$s ( n ) = {\sum }_{k = 1}^{p} {a}_{k} s ( n - k ) + e ( n )$$

In this equation, the ak terms designate the coefficients of an AR type filter modeling the vocal tract and the e(n) term is the residual signal relating to the excitation portion, where n is a signal frame index. It should be observed that if the order of the model is sufficient large, then e(n) is not correlated with s(n).

Formally this is written E[e(n)s(n−m)]=0 for all integer m, where E[.] designates mathematical expectation.

In practice, typical orders of 10 and 16 are selected for speech signals when sampled respectively at 8 kilohertz (kHz) and at 16 kHz.

Multiplying the left- and right-hand sides of the above equation by s(n−m) and proceeding to mathematical expectation, leads to the Yule-Walker equations defined by:

$$r ( m ) = - {\sum }_{k = 1}^{p} {a}_{k} r ( m - k )$$

where r is the autocorrelation function defined by:

r(m)=E[s(n)s(n−m)]

An estimator for r(m) is given by:

$$r ( m ) = \frac{1}{N - p} {\sum }_{n = 1}^{N - p} s ( n ) s ( n - m )$$

In practice, only the first p+1 values of the autocorrelation function are needed for estimating the filter coefficients aₖ. The above equation can be expressed in matrix form leading to resolution of the following linear system:

$$[ \begin{matrix}r ( 0 ) & r ( 1 ) & … & r ( p - 1 ) \\ r ( 1 ) & r ( 0 ) & … & r ( p - 2 ) \\ ⋮ & ⋮ & ⋱ & ⋮ \\ r ( p - 1 ) & r ( p - 2 ) & … & r ( 0 )\end{matrix} ] [ \begin{matrix}{a}_{1} \\ {a}_{2} \\ ⋮ \\ {a}_{p}\end{matrix} ] = [ \begin{matrix}r ( 1 ) \\ r ( 2 ) \\ ⋮ \\ r ( p )\end{matrix} ] .$$

Thus, estimating the coefficients amounts to inverting a Toeplitz matrix, which can be achieved using conventional procedures and in particular with the help of the algorithm described by J. Durbin in “The fitting of time-series models”, Rev. Inst. Int. Statistics.

In a variant, the decomposition step 12 serves to obtain a parametric model for the excitation, in addition to the residue.

For example, the excitation-filter decomposition is performed using a priori information about the excitation. Thus, the excitation can be modeled by integrating information associated with the speech production process, in particular via a parametric model for the derivative of the glottal flow wave (DGFW) such as, for example, the LF model proposed by Liljencrants and Fant in “A four-parameter model of glottal flow” STL-QPSR, Vol. 4, pp. 1-13, 1985. That model is fully defined by data for the fundamental period T0, by three form parameters that are open quotients of periods, an asymmetry coefficient, and a return phase coefficient, by a position parameter corresponding to the instant of glottal closure, and by a term b0 characterizing the amplitude of the DGFW.

In this context, the speech signal may be represented by the following exogenous autoregression model ARX-LF:

$$s ( n ) = {\sum }_{k = 1}^{p} {a}_{k} s ( n - k ) + {b}_{0} u ( n ) + e ( n )$$

where u(n) designates the signal corresponding to the LF model of the DGFW.

It is difficult to estimate simultaneously both the parameters of the DGFW and the parameters associated with the filter, in particular optimization in terms of form parameters and position parameters is a non-linear problem. Nevertheless, when T0 and u are constant, optimization in terms of the parameters ak and b0 is a conventional linear problem, for which a least-squares estimator can be obtained analytically. On the basis of observation, an effective method is proposed by D. Vincent, O. Rosec, and T. Chonavel, in the publication “Estimation of LF glottal source parameters based on ARX model”, Interspeech'05, pp. 333-336, Lisbon, Portugal, 2005.

In this implementation, at the end of the estimation procedure, the method provides:
parameters characterizing the DGFW completely using the LF model;
filter parameters aₖ; and
the residue e(n) corresponding to the modeling error associated with the ARX-LF model.

In general, at the end of step 12, the method delivers a model of the speech signal s(n) in the form of a parametric portion and of a residue that is not parametric.

Thereafter, the analysis step 10 comprises estimating 14 the temporal envelope of the residue.

In the implementation described, the temporal envelope is defined as the modulus of the analytic signal, and it is obtained by a so-called Hilbert transform. Thus, the temporal envelope d(t) of the residue e(t) is written:

d(t)=|xₑ(t)| with xₑ(t)=e(t)+iH(e(t)),

where H designates the Hilbert transform operation.

Advantageously, estimation 14 includes smoothing the temporal envelope of the residue. This provides a better estimate in particular for voiced sounds for which the envelope is periodic with period T0, where T0 designates the inverse of the fundamental frequency f₀. For example, it is possible to use cepstrum modeling of order K for the envelope. This is written in the form:

$$ln ( d ( n ) ) = \frac{1}{2} {\sum }_{k = - K}^{K} {c}_{k} exp ( 2 i π {knf}_{0} / {f}_{s} ) ɛ ( n )$$

The cepstrum coefficients ck are then estimated by minimizing □(n) in the least-squares sense. More precisely, the above equation is written in the following matrix form:

$$d = Mc + ɛ with$$

$$d = {\frac{1}{2} [ ln ( d ( - N ) ) , … , ln ( d ( N ) ) ]}^{T} {M}_{n + ( N + 1 ) , k + ( K + 1 )} = exp ( 2 i π kn {f}_{0} / {f}_{s} ) , n ∈ \{ - N , … , N \} , k ∈ \{ - K , … , K \} and \\ c = {[ {c}_{- K} , … , {c}_{K} ]}^{T}$$

In the above equations, the exponent T represents the transposition operator. The best solution in the least-squares sense is then:

c=(M^{H}M)⁻¹M^{H}d

where H designates the Hermitian transposition operator. The corresponding envelope is written as follows:

$$\hat{d} ( n ) = exp ( \frac{1}{2} {\sum }_{k = - K}^{K} {\hat{c}}_{k} exp ( 2 i π kn {f}_{0} / {f}_{s} ) )$$

Once the temporal envelope of the residue has been estimated, the method comprises a step 16 of temporal normalization of the residue. In this document, temporal normalization means obtaining a residue that is substantially invariant with respect to time, and more precisely obtaining a residue having a temporal envelope that is constant.

In the implementation described, step 16 is implemented by dividing the residue by the expression for the temporal envelope using the following equation:

$$\tilde{e} ( n ) = \frac{e ( n )}{\hat{d} ( n )}$$

In parallel with the analysis 10, the method has a step 18 of determining instructions for modifying the speech signal. These instructions may be of two types.

In first circumstances, a target is defined for each of the parameters to be modified. This applies in particular when synthesizing speech for which numerous algorithms exist for predicting duration, fundamental frequency, or indeed energy. For example, values for fundamental frequency and energy can be estimated for the beginning and the end of each syllable, or indeed for each phoneme of the utterance. Similarly, the duration of each syllable or of each phoneme can be predicted. Given these numerical targets and the speech signal, modification coefficients can be obtained by obtaining the ratio between the measurements performed on the signal and the value for the corresponding target.

In second circumstances, such targets are not available, but it is possible to define a set of modification coefficients for modifying the desired parameters. For example, a fundamental frequency modification coefficient of 0.5 enables the perceived voice pitch to be divided by 2. Observe that these modification coefficients can be defined globally for the entire utterance or in more local manner, for example on the scale of a syllable or of a word.

Thereafter, the method comprises a step 20 of modifying the speech signal s(n) in compliance with the previously determined instructions.

The modifications performed relate to the fundamental frequency, the duration, and the energy of the speech signals. In addition, when implementing analysis that makes use of a DGFW, given that a source-filter type decomposition is available, voice quality parameter modifications can be performed by altering the open quotient, the asymmetry coefficient, or indeed the return phase coefficient.

Modification step 20 begins with modification 22 of the parametric portion of the model corresponding to the speech signal and to the normalized residue.

In the implementation described, this modification applies to the fundamental frequency and to duration, and it is implemented conventionally by a technique known as time domain pitch synchronous overlap and add (TD-PSOLA) as described in the publication “Non-parametric techniques for pitch-scale and time-scale modification of speech” Speech Communication, Vol. 16, pp. 175-205, 1995, by E. Moulines and J. Laroche.

That technique makes it possible to modify simultaneously both the duration and the fundamental frequency with respective coefficients □(t) and □(t).

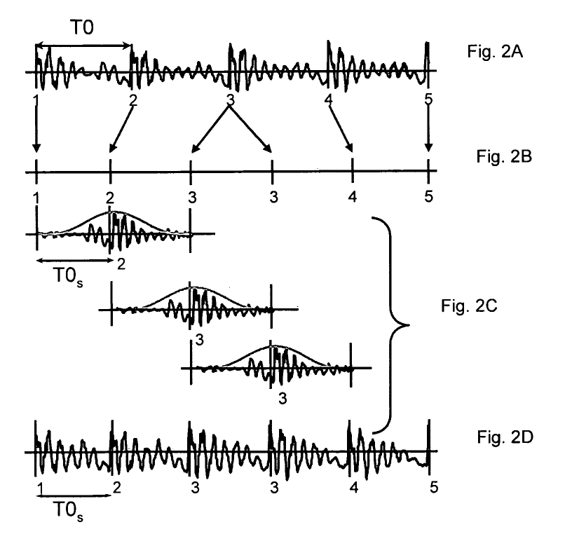

With reference to FIGS. 2A to 2D, the principal steps in the operation of the TD-PSOLA technique are shown.

FIG. 2A represents the speech signal s(n) that is to be modified. During a step 24, the signal is segmented into frames in the so-called pitch-synchronous manner, i.e. each segment has a duration corresponding to the reciprocal of the fundamental frequency of the signal.

The glottal closure instants, also referred to as analysis instants, are situated close to the energy maxima in the speech signal, and TD-PSOLA treatments provide good preservation of the characteristics of the speech signal in the vicinity of the ends of the segments obtained by pitch-synchronous analysis. Thus, when these instants are identified with satisfactory accuracy, the performance of TD-PSOLA is optimized. By way of example, such pitch-synchronous segmentation is obtained using techniques based on group delay or indeed on the method proposed by D. Vincent, O. Rosec, and T. Chonavel, in the publication “Glottal closure instant estimation using an appropriateness measure of the source and continuity constraints”, IEEE ICASSP'06, Vol. 1, pp. 381-384, Toulouse, France, May 2006.

Advantageously, this step of pitch-synchronous marking is performed off-line, i.e. not in real time, thus serving to reduce computation load in a real time implementation.

As a function of the modification factors desired for fundamental frequency and for duration, the instants separating the segments are modified in application of the following rules:
to lengthen duration, certain segments are duplicated so as to increase artificially the number of glottal pulses;
to shorten duration, certain segments are discarded;
to increase the fundamental frequency, i.e. to provide a higher-pitch rendering, the analysis instants are moved closer together, which might require segments to be duplicated in order to conserve total duration; and
to reduce the fundamental frequency, i.e. to provide lower-pitch rendering, the analysis instants are spaced apart, which might require some segments to be discarded in order to conserve total duration.

A detailed description of these rules is to be found in the publication “Non-parametric techniques for pitch-scale and time-scale modification of speech” Speech Communication, Vol. 16, pp. 175-205, 1995, by E. Moulines and J. Laroche.

At the end of this step, the signal has an integer number of segments or frames, each of duration corresponding to a period that is the reciprocal of the modified fundamental frequency, as shown in FIG. 2B.

Thereafter, the processing of the modification comprises a step 26 of windowing the signal about the analysis instants, i.e. instants separating segments. During this windowing, for each analysis instant, a portion of the windowed signal around said instant is selected. This signal portion is referred to as the “short-term signal” and in this example it extends over a duration corresponding to the modified fundamental period, as shown with reference to FIG. 2C.

Finally, the processing of the modification comprises a step 28 of summing the short-term signals, which are recentered on the synthesis instants and added as shown with reference to FIG. 2D.

In a variant, step 22 can be performed by using a harmonic plus noise model (NHM) type technique, or a phase vocodeur type technique. The modifications in fundamental frequency and duration can also be implemented using other techniques.

Below, the modified normalized residue, i.e. the normalized residue for which the fundamental frequency and/or duration information has been modified, is written \tilde{e}^{modif} (n).

Thereafter, the method comprises a step 30 of modifying the temporal envelope of the residue. More precisely, this step enables the original temporal characteristics of the residue to be replaced by temporal characteristics that are in agreement with the desired modifications.

Step 30 begins by determining 32 new temporal characteristics for the residue. In this example, this comprises modifying the temporal envelope of the residue, as obtained at the end of step 14.

As mentioned above, when considering a pitch-synchronous frame of the signal, two types of modification can be performed either together or individually:
modifying the fundamental frequency; and
modifying the parameters associated with voice quality.

Modifying the fundamental frequency consists in modifying the temporal envelope so as to make it match the normalized residue having a fundamental frequency that has previously been modified.

One implementation of such a modification consists in expanding/contracting the original temporal envelope \hat{d}(n) so as to preserve its general shape.

Given the value of the modified fundamental frequency f₀^{modif}, the modified temporal envelope d^{modif} can then be written as follows:

$${d}^{modif} ( n ) = exp ( \frac{1}{2} {\sum }_{k = - K}^{K} {\hat{c}}_{k} exp ( 2 i π {knf}_{0}^{modif} / {f}_{s} ) )$$

When modifications are made to the parameters associated with voice quality, the shape of the temporal envelope needs to be modified. For example, when modifications are made to the open coefficient, it is appropriate to apply different expansion/contraction factors respectively to the open and closed portions of the glottal cycle.

For example, the open quotient is modified so that the duration of the open phase becomes Tₑ^{modif} with Tₑ^{modif}<T0 where T0 is the length of a glottal cycle having its closure instant coinciding with the time origin and an original open phase of duration Te. Under such circumstances, in order to conserve the same fundamental period, it is appropriate to expand the signal using the following coefficients:

$$\begin{matrix}{α}_{1} = \frac{{T}_{0} - {T}_{e}^{modif}}{{T}_{0} - {T}_{e}} for the closed phase \\ {α}_{2} = \frac{{T}_{e}^{modif}}{{T}_{e}} for the open phase\end{matrix}$$

Mathematically, this amounts to determining a temporal envelope having the following form:

$${d}^{modif} ( t ) = exp ( \frac{1}{2} {\sum }_{k = - K}^{K} {\hat{c}}_{k} exp ( 2 i π kg ( t / {T}_{0}^{modif} ) )$$

where the function g is defined by:

$$g ( t ) \{ \begin{matrix}\frac{{T}_{0} - {T}_{e}^{modif}}{{T}_{0} - {T}_{e}} t & for t ∈ [ 0 , {T}_{0} - {T}_{e} ] \\ {T}_{0} - {T}_{e}^{modif} + \frac{{T}_{e}^{modif}}{{T}_{e}} ( t - ( {T}_{0} - {T}_{e} ) ) & for t ∈ [ {T}_{0} - {T}_{e ′} {T}_{0} ]\end{matrix}$$

Naturally, other types of modification can be performed on the voice quality parameters using similar principles.

Thereafter, step 30 comprises a step 34 of determining the new residue. In this example, the new residue is obtained by multiplying the residue \tilde{e}^{modif} (n) by the modified envelope d^{modif}.

The original residue has thus been normalized, modified, and then combined with the new temporal envelope. This ensures that the temporal envelope sound corresponds to the fundamental frequency and/or voice quality modifications.

In the implementation described, the excitation coincides with the residue, which corresponds to the situation in which the residue is obtained merely by inverse linear filtering, and the excitation does not include a parametric portion.

When the excitation is made up of a glottal source that can be modeled by a parametric model and a residue, it is appropriate to perform the same type of modification on the glottal source as parameterized in this way by adjusting the fundamental frequency and voice quality parameters.

Finally, the method includes a step 40 of synthesizing the modified signal. This synthesis consists in filtering the signal obtained at the end of step 20 via the vocal tract filter as defined during step 12. Step 40 also includes adding and overlapping the frames as filtered in this way. This synthesis step is conventional and is not described in greater detail herein.

Thus, the processing specific to the temporal envelope of the residue serves to obtain a modification that ensures good time coherence.

Naturally, other implementations could be envisaged.

Firstly, the residue may be decomposed into sub-bands. Under such circumstances, steps 14, 16, and 20 are performed on all or some of the sub-bands considered separately. The final residue that is obtained is then the sum of the modified residues coming from the various sub-bands.

In addition, the residue may be subjected to decomposition that is deterministic in part and stochastic in part. Under such circumstances, steps 14, 16, and 20 are performed on each of the parts under consideration. Then likewise, the final residue that is obtained is the sum of the modified deterministic and stochastic components.

In addition, these two variants can be combined, so that separate processing on each sub-band and for each of the deterministic and stochastic components can be performed.

In another implementation, the various steps of the invention can be performed in a different order. For example, the temporal envelope can be modified before modifications are made to the signal. Thus, the modifications are applied to the residue with its new temporal envelope and not to the normalized residue as in the example described above.

In another implementation, the steps of normalizing the residue and of determining new temporal characteristics are combined. In such an implementation, the residue is modified directly by a time factor that is determined from its temporal envelope and from modification instructions. The time factor serves simultaneously to eliminate any dependency of the residue on its original temporal characteristics, and to apply new temporal characteristics.

Furthermore, the invention can be implemented by a program containing specific instructions that, on being instituted by a computer, lead to the above-described steps being performed.

The invention can also be implemented by a device having appropriate means such as microprocessors, microcomputers, and associated memories, or indeed programmed electronic components.

Such a device can be adapted to implement any implementation of the method as described above.

What is claimed is:

1. A method of modifying the acoustic characteristics of a speech signal, the method comprising:
decomposing the signal into a parametric portion and a non-parametric residue;
estimating temporal envelope of the residue;
modifying acoustic characteristics of the parametric portion and of the residue in compliance with modification instructions;
determining a new temporal envelope for the modified residue using said modification instructions; and
synthesizing a modified speech signal from the modified parametric portion and from the residue as modified and with the new temporal envelope.

2. A method according to claim 1, wherein said decomposition of the signal is decomposition in application of an excitation-filter type model.

3. A method according to claim 1, wherein estimating the temporal envelope of the residue comprises estimating a first envelope and then performing temporal smoothing on said first envelope.

4. A method according to claim 1, further comprising temporal normalization of the residue as a function of the estimated temporal envelope.

5. A method according to claim 4, wherein the temporal normalization of the residue comprises dividing the residue by the estimated temporal envelope.

6. A method according to claim 4, wherein the determination of a new temporal envelope for the residue comprises modifying parameters of the temporal envelope of the residue in compliance with said modification instructions and applying the modified temporal envelope to the normalized residue.

7. A method according to claim 1, wherein estimating the temporal envelope and determining the new temporal envelope are the same operation.

8. A method according to claim 1, wherein modifying the acoustic characteristics comprises modifying fundamental frequency and duration information concerning both the parametric portion and the residue.

9. A computer program medium for a device for modifying a speech signal, the program including instructions which, upon execution by a computer of said device, lead to a method according to claim 1 being implemented.

10. A device for modifying a speech signal, comprising:
means for decomposing the signal into a parametric portion and a non-parametric residue;
means for estimating a temporal envelope of the residue;
means for modifying acoustic characteristics of the parametric portion and of the residue in application of modification instructions;
means for determining a new temporal envelope for the modified residue responsive to said modification instructions; and
means for synthesizing a modified speech signal from the modified parametric portion and from the residue as modified and with the new temporal envelope.

11. A device according to claim 10, wherein said decomposition of the signal is decomposition in application of an excitation-filter type model.

12. A device according to claim 10, wherein said means for estimating the temporal envelope of the residue comprises means for estimating a first envelope and then performing temporal smoothing on said first envelope.

13. A device according to claim 10, further comprising means for performing temporal normalization of the residue as a function of the estimated temporal envelope.

14. A device according to claim 13, wherein the means for performing temporal normalization of the residue comprises means for dividing the residue by the estimated temporal envelope.

15. A device according to claim 13, wherein the means for determining a new temporal envelope for the residue comprises means for modifying parameters of the temporal envelope of the residue in compliance with said modification instructions and applying the modified temporal envelope to the normalized residue.

16. A device according to claim 10, wherein means for estimating the temporal envelope and means for determining the new temporal envelope are formed together.

17. A device according to claim 10, wherein means for modifying the acoustic characteristics comprises means modifying fundamental frequency and duration information concerning both the parametric portion and the residue.
